(19) United States
(12) Patent Application Publication
(10) Pub. No.: US 2015/0051919 A1
(43) Pub. Date: Feb. 19, 2015

(54) SERVER DEVICE, DATA LINKING METHOD, AND COMPUTER PROGRAM

(71) Applicant: Sony Corporation, Tokyo (JP)

(72) Inventors: Gakuho Fukushi, Tokyo (JP); Yoshinori Takagi, Kanagawa (JP); Shinsuke Araya, Kanagawa (JP); Yoichi Kobori, Kanagawa (JP); Yuya Horiuchi, Kanagawa (JP)

(73) Assignee: Sony Corporation, Tokyo (JP)

(21) Appl. No.: 14/391,434

(22) PCT Filed: Mar. 21, 2013
(86) PCT No.: PCT/JP2013/058032

§ 371 Date: Oct. 9, 2014

(30) Foreign Application Priority Data
Apr. 27, 2012 (JP) 2012-102281

(51) Int. Cl. G06F 19/00; H04L 29/08

(52) U.S. Cl. CPC G06F 19/322; H04L 67/12
USPC 705/3

(57) ABSTRACT

There is provided a server device including a data retaining unit configured to retain at least data of each individual, without retaining information that identifies a specific individual, and a data registration unit configured to acquire at least data of each individual from another system retaining at least information that identifies a specific individual and the data of each individual, and register the data of each individual in the data retaining unit. The data registration unit acquires data from the another system using a linking ID for making a linkage with the another system, and registers the data in the data retaining unit.

### TECHNICAL FIELD

The present disclosure relates to a server device, a data linking method, and a computer program.

### BACKGROUND ART

Currently, prescriptions issued by medical doctors, medicine notebooks issued at pharmacies are practiced by means of paper medium. However, in view of convenience and efficiency improvement, there is a demand for construction of a system for electronically sharing and managing health data such as what is referred to as electric health record (EHR). In current situation, efforts such as, for example, share of electronic medical records, electronization of prescriptions, and electronization of medicine notebooks, are promoted.

Also, for example, as the technology related to the medicine notebook, there is proposed a technology in which information such as a name and an administration method of a medicine is recorded in advance, and a medicine instruction manual is generated and printed on the basis of the information (refer to, for example, Patent Literature 1). In this technology, in order to enable the information relevant to the medicine to be stored in the notebook owned by a patient and the like as well, information to be stored is provided at a part of the medicine instruction manual.

### CITATION LIST

### Patent Literature

Patent Literature 1: JP H11-28877A

### SUMMARY OF INVENTION

### Technical Problem

In the aforementioned system for sharing and managing the health data such as the electronized medicine notebook (electronic medicine notebook) and the prescription, individual information of each user is handled, and therefore improvement of security is desired. Therefore, technologies to improve the security have been devised in the system for sharing and managing the health data such as the medicine notebook and the prescription.

Also, although the electronic medicine notebook acquires real-time data and accumulates information, since the timing of data acquisition is when a user spontaneously presents the data, there is an aspect that comprehensiveness of the information is missing and information is limited. Also, there is a case where the individual information erroneously typed, or a case where a part of information remains unclassified.

Therefore, the present disclosure proposes a novel and improved server device, a data linking method, and a computer program capable of enhancing the security of the electronized health data and enhancing the reliability of the information.

### Solution to Problem

According to the present disclosure, there is provided a server device including a data retaining unit configured to retain at least data of each individual, without retaining information that identifies a specific individual, and a data registration unit configured to acquire at least data of each individual from another system retaining at least information that identifies a specific individual and the data of each individual, and register the data of each individual in the data retaining unit. The data registration unit acquires data from the another system using a linking ID for making a linkage with the another system, and registers the data in the data retaining unit.

According to the present disclosure, there is provided a data linking method including a step of acquiring at least data of each individual from another system retaining at least information that identifies a specific individual and the data of each individual, and registering the data in a data retaining unit retaining at least data of each individual without retaining information that identifies a specific individual. In the step of registering in the data retaining unit, data is acquired from the another system using a linking ID for making a linkage with the another system, and is registered in the data retaining unit.

According to the present disclosure, there is provided a computer program causing a computer to execute a step of acquiring at least data of each individual from another system retaining at least information that identifies a specific individual and the data of each individual, and registering the data in a data retaining unit retaining at least data of each individual without retaining information that identifies a specific individual. In the step of registering in the data retaining unit, data is acquired from the another system using a linking ID for making a linkage with the another system, and is registered in the data retaining unit.

### Advantageous Effects of Invention

As described above, the present disclosure provides a novel and improved server device, a data linking method, and a computer program capable of enhancing the security of the electronized health data and enhancing the reliability of the information.

### BRIEF DESCRIPTION OF DRAWINGS

FIG. 1 is an explanatory diagram illustrating an exemplary configuration of an information processing system 1 according to one embodiment of the present disclosure.

FIG. 2 is an explanatory diagram illustrating an exemplary configuration of a data center 100 included in an information processing system 1 according to one embodiment of the present disclosure.

FIG. 3 is an explanatory diagram illustrating an exemplary configuration of a hospital system 300 included in an information processing system 1 according to one embodiment of the present disclosure.

FIG. 4 is an explanatory diagram illustrating an exemplary configuration of a pharmacy system 400 included in an information processing system 1 according to one embodiment of the present disclosure.

FIG. 5 is an explanatory diagram illustrating an example of individual and medication-history information recorded in a pharmacy database 410 of a pharmacy system 400.

FIG. 6 is an explanatory diagram illustrating a specific example of user medication history information recorded in a server database 111 of a data server 110.

FIG. 7 is a flow diagram illustrating an exemplary registration process of user medication history information by a pharmacy system 400.

FIG. 8 is a flow diagram illustrating an exemplary registration process of user medication history information by a pharmacy system 400.

FIG. 9 is an explanatory diagram illustrating an overview of operation of an information processing system 1 according to the present embodiment.

FIG. 10 is a flow diagram illustrating one example of processing operation of an information processing system 1 according to one embodiment of the present disclosure.

FIG. 11 is an explanatory diagram illustrating an overview of operation of an information processing system 1 according to the present embodiment.

FIG. 12 is a flow diagram illustrating one example of processing operation of an information processing system 1 according to one embodiment of the present disclosure.

FIG. 13 is an explanatory diagram illustrating an operation overview of an information processing system 1 according to the present embodiment.

FIG. 14 is a flow diagram illustrating one example of processing operation of an information processing system 1 according to one embodiment of the present disclosure.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Also, the present disclosure will be described in the order of the below items.

### <1. One Embodiment of Present Disclosure>

[Exemplary System Configuration]

[Exemplary Data Center Configuration]

[Exemplary Hospital System Configuration]

[Exemplary Pharmacy System Configuration]

[Specific Example of Pharmacy Database]

[Specific Example of Server Database]

[Exemplary Registration Process of User Medication History Information]

### <2. Conclusion>

### 1. One Embodiment of Present Disclosure

### Exemplary System Configuration

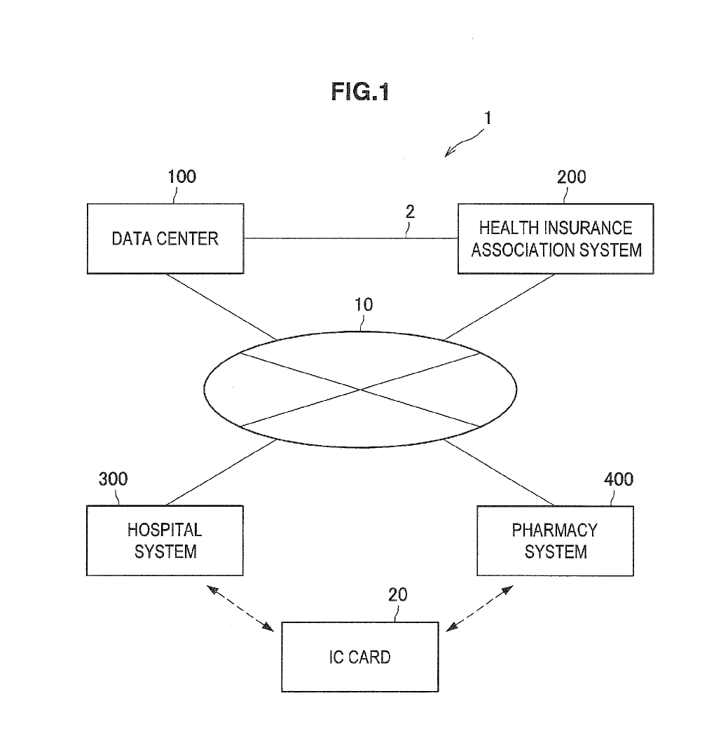

First, with reference to drawings, description will be made of an exemplary configuration of an information processing system according to one embodiment of the present disclosure. FIG. 1 is an explanatory diagram illustrating the exemplary configuration of the information processing system 1 according to one embodiment of the present disclosure. In the following, using FIG. 1, description will be made of the exemplary configuration of the information processing system 1 according to one embodiment of the present disclosure.

As shown in FIG. 1, the information processing system 1 according to one embodiment of the present disclosure includes a data center 100, a health insurance association system 200, a hospital system 300, and a pharmacy system 400. As shown in FIG. 1, the data center 100, the health insurance association system 200, the hospital system 300, and the pharmacy system 400 are connected to each other via a network 10.

The data center 100 stores the information transmitted via the network 10 from the health insurance association system 200, the hospital system 300, and the pharmacy system 400. The information transmitted via the network 10 from the health insurance association system 200, the hospital system 300, and the pharmacy system 400 and stored in the data center 100 is, for example, the data relevant to health of each individual. The data relevant to health includes, for example, medical treatment information and medicine dispensing information of each individual. Also, the data center 100 provides the recorded information in response to a request from the hospital system 300 and the pharmacy system 400. In the below description, the information stored in the data center 100 is described as the data relevant to health of each individual. Note that the exemplary configuration of the data center 100 will be described later.

The health insurance association system 200 stores electronic rezept data that is generated based on medical treatment information and medicine dispensing information which are transmitted from the medical institution using the hospital system 300 and the pharmacy using the pharmacy system 400. The electronic rezept data retained by the health insurance association system 200 is provided to the data center 100 automatically or in response to a request from the data center 100.

Since the information exchanged between the data center 100 and the health insurance association system 200 is the medical treatment information and the medicine dispensing information which are very sensitive information, it is desired to connect between the data center 100 and the health insurance association system 200 with a secure communication line 2 such as a dedicated line and a virtual private network (VPN), aside from the network 10.

The hospital system 300 is a system provided in the hospital which a patient (user) visits. The hospital system 300 retains individual and physical-examination information of each patient, which includes individual information of a patient, medication history data as health data which is data relevant to the health of a patient, and the like. For example, the individual and physical-examination information includes the physical examination data composed of the information relevant to a prescription issued to a patient in the hospital or the like, and others. The individual and physical-examination information retained in the hospital system 300 is transmitted to the data center 100 through the network 10. Note that, when the information is transmitted from the hospital system 300 to the data center 100, the information singling out an individual user is not transmitted. The exemplary configuration of the hospital system 300 will be described later.

The pharmacy system 400 is a system provided in the pharmacy where a patient buys prescribed medicine. The pharmacy system 400 retains individual and medication-history information of each patient, which includes individual information of a patient and medication history data as health data which is data relevant to the health of a patient, and the like. For example, the individual and medication-history information includes information relevant to medicine dispensed for a patient in the pharmacy or the like, and the medicine dispensing data composed of information relevant to the medicine and others. The individual and physical-examination information retained by the pharmacy system 400 is transmitted through the data center 100 to the network 10. Note that, when the information is transmitted from the pharmacy system 400 to the data center 100, the information singling out an individual user is not transmitted. The exemplary configuration of the pharmacy system 400 will be described later.

In FIG. 1, the IC card 20 used in the hospital system 300 and the pharmacy system 400 is also illustrated. The IC card 20 stores an individual identification ID which is an ID unique to a patient, and executes contactless proximity communication by a predetermined frequency with the reader-writers 330, 430, which are described later, to provide the individual identification ID to the reader-writers 330, 430.

Here, the individual identification ID is the identification information for singling out a user uniquely, but is generally considered as information not singling out (or with which it is difficult to single out) an individual user identifiable by the individual identification ID, even if the individual identification ID is obtained by somebody. For example, individual information such as a name, an address, a telephone number of a user can single out a user almost directly from those information. However, if an ID composed of numbers, symbols, and the like is given to a user as an individual identification ID, it is difficult to single out the user of the individual identification ID from the individual identification ID, without knowing the correspondence between the individual identification ID and the user.

Note that a medium that may cause an acquisition of the individual identification ID is not limited to the IC card and the like to which the individual identification ID is directly recorded, but may be a unique medium that is not rewritable or replaceable. For example, when the unique information is acquired from biological information as the individual identification ID, the medium for acquiring the individual identification ID can be a part or whole of a human body or the like.

In the above, the exemplary configuration of the information processing system 1 according to one embodiment of the present disclosure is described using FIG. 1. Next, description will be made of the exemplary configuration of each system for configuring the information processing system 1 according to one embodiment of the present disclosure.

### Exemplary Data Center Configuration

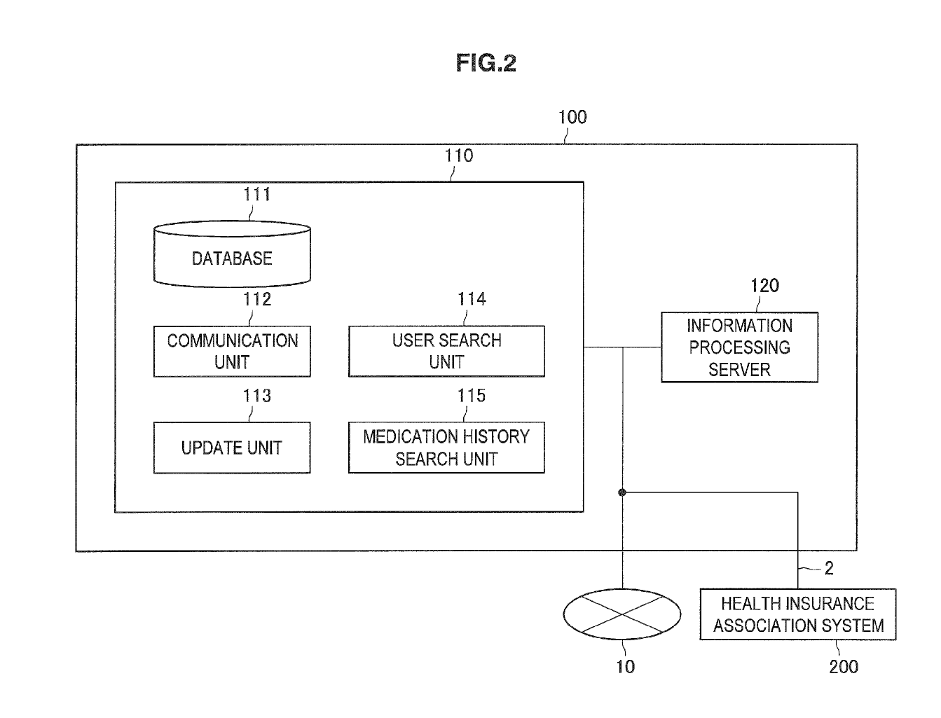

FIG. 2 is an explanatory diagram illustrating an exemplary configuration of the data center 100 included in the information processing system 1 according to one embodiment of the present disclosure. In the following, the exemplary configuration of the data center 100 is described using FIG. 2.

As shown in FIG. 2, the data center 100 includes a data server 110, and an information processing server 120.

The data server 110 manages the medication history data supplied from the hospital system 300 and the pharmacy system 400, and provides the recorded medication history data in response to a request from the hospital system 300 and the pharmacy system 400. The data server 110 includes a server database 111, a communication unit 112, an update unit 113, a user search unit 114, and a medication history search unit 115.

The server database 111 records the medication history information of each patient. This medication history information of each patient includes information singling out a pharmacy that uses the pharmacy system 400, patient identification information used in the pharmacy system 400, patient medication history data supplied from the pharmacy system 400, and others.

The communication unit 112 communicates with the hospital system 300 and the pharmacy system 400 via the network 10, and transmits and receives data such as the medication history data. Also, the communication unit 112 transmits the data to and receives the data from the health insurance association system 200 via the secure communication line 2, for example. When the data is supplied from the hospital system 300 and the pharmacy system 400, the update unit 113 updates the server database 111 on the basis of the data.

Also, in the present embodiment, the update unit 113 updates the server database 111 on the basis of the electronic rezept data retained by the health insurance association system 200. The update unit 113 updates the server database 111 on the basis of the electronic rezept data retained by the health insurance association system 200, so that the data server 110 improves the information reliability of the electronized health data retained in the server database 111.

The user search unit 114 searches the information for singling out a targeted patient, i.e., patient identification information used in the pharmacy system 400, from the medication history information recorded in the server database 111. The medication history search unit 115 searches a targeted patient medication history data, from the medication history information recorded in the server database 111.

The information processing server 120 accesses the server database 111 of the data server 110 as necessary, and executes the computation of the medication history information, notification process to the patient based on the medication history information, and others.

In the above, the exemplary configuration of the data center 100 is described using FIG. 2. Next, description will be made of the exemplary configuration of the hospital system 300 included in the information processing system 1 according to one embodiment of the present disclosure.

### Exemplary Hospital System Configuration

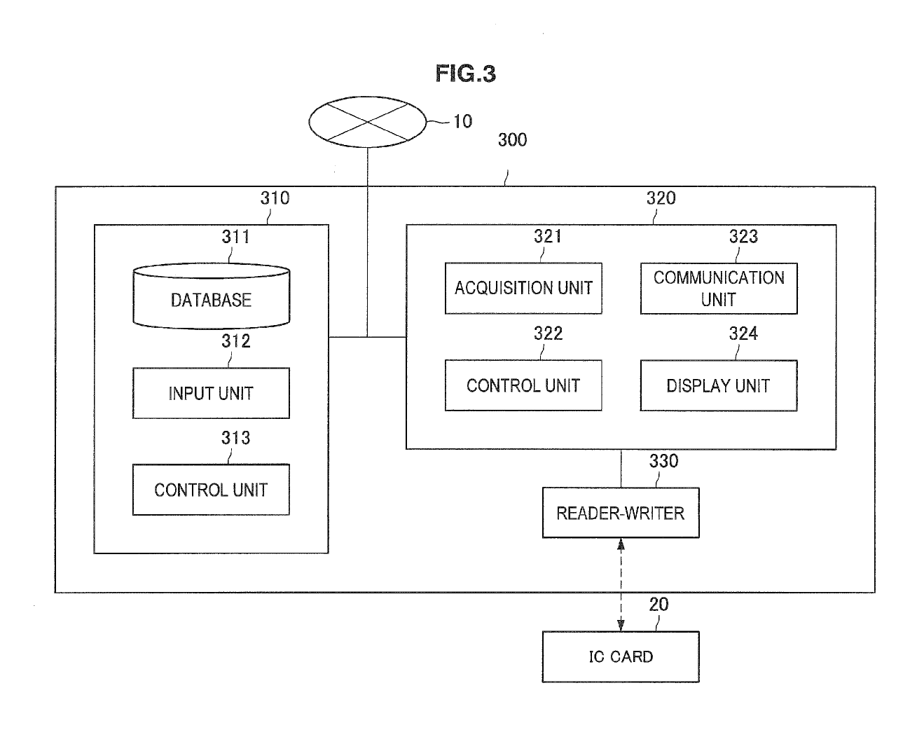

FIG. 3 is an explanatory diagram illustrating an exemplary configuration of the hospital system 300 included in the information processing system 1 according to one embodiment of the present disclosure. In the following, the exemplary configuration of the hospital system 300 will be described using FIG. 3.

As shown in FIG. 3, the hospital system 300 includes a hospital rezept computer 310, a hospital device 320, and a reader-writer 330. The hospital rezept computer 310, the hospital device 320 are connected to each other via a local network. This local network is connected to the network 10 by a router (not illustrated in the drawings).

The hospital rezept computer 310 includes a hospital database 311, an input unit 312, and a control unit 313. The hospital rezept computer 310 updates the information of the hospital database 311 in response to input manipulation of the input unit 312 by a medical doctor, a staff member, and others of the hospital.

The hospital database 311 builds and retains a database of the individual and physical-examination information of each patient which is composed of individual information of patients, medication history data as health data which is data relevant to health of patients, and others. The medication history data included in the individual and physical-examination information includes the physical examination data composed of information relevant to prescriptions issued to patients in the hospital or the like, and others. The medication history data recorded in the hospital database 311 is transmitted to and recorded in the data center 100 as necessary, and is shared in a plurality of hospital systems 300 and pharmacy systems 400.

The input unit 312 is, for example, an input device composed of a keyboard, a mouse, a touch panel, and the like, and supplies information in response to the input manipulation of the user, to the control unit 313. The control unit 313 controls the operation of the hospital rezept computer 310, in response to the information supplied from the input unit 312.

The hospital device 320 is, for example, composed of a desktop computer, a notebook computer, or the like. The hospital device 320 executes various process in response to the individual identification ID supplied from the reader-writer 330, and the input manipulation of a medical doctor, a staff member, or others. As shown in FIG. 3, the hospital device 320 includes an acquisition unit 321, a control unit 322, a communication unit 323, and a display unit 324.

The acquisition unit 321 acquires the individual identification ID acquired by the reader-writer 330 by the contactless proximity communication with the IC card 20. The control unit 322 executes controls for exchanging various data with the hospital rezept computer 310 via a local area network, and for causing the display unit 324 to display various data.

The communication unit 323 transmits information to and receives information from other devices via the local area network and the network 10. The display unit 324 displays various data (text information, image information, and the like).

The reader-writer 330 is connected to the hospital device 320 by a USB (Universal Serial Bus) and other interface, and performs contactless proximity communication by a predetermined frequency (for example, 13.56 MHz) with the IC card 20. By performing the contactless proximity communication with the IC card 20, the reader-writer 330 provides the individual identification ID acquired from the IC card 20, to the hospital device 320.

In the above, the exemplary configuration of the hospital system 300 is described using FIG. 3. Note that the hospital rezept computer 310, the hospital system 320, and the reader-writer 330 illustrated in FIG. 3 may be configured by one device. Next, an exemplary configuration of the pharmacy system 400 is described.

### Exemplary Pharmacy System Configuration

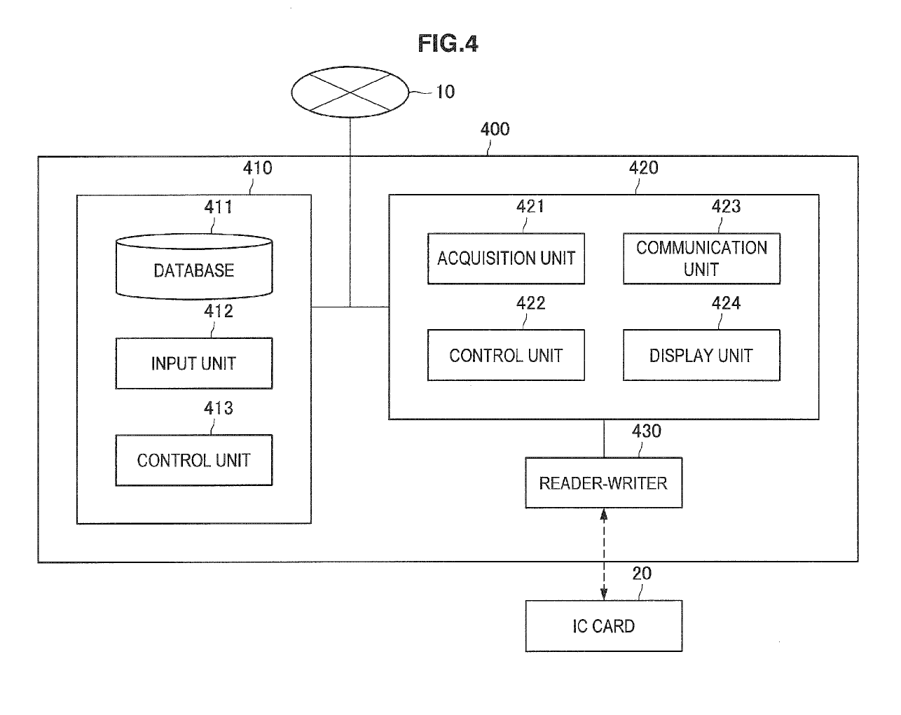

FIG. 4 is an explanatory diagram illustrating an exemplary configuration of the pharmacy system 400 included in the information processing system 1 according to one embodiment of the present disclosure. In the following, the exemplary configuration of the pharmacy system 400 will be described using FIG. 4.

As shown in FIG. 4, the pharmacy system 400 includes a pharmacy rezept computer 410, a pharmacy device 420, and a reader-writer 430. The pharmacy rezept computer 410 and the pharmacy device 420 are connected to each other via a local network. This local network is connected to the network 10 by a router (not illustrated in the drawings).

The pharmacy rezept computer 410 includes a pharmacy database 411, an input unit 412, and a control unit 413. The pharmacy rezept computer 410 updates the information of the pharmacy database 411 in response to input manipulation of the input unit 412 by a pharmacist, a staff member, and others of the pharmacy.

The pharmacy database 411 builds and retains a database of the individual and medication-history information of each patient which is composed of individual information of patients, health data which is data relevant to health of patients, and others. The health data includes data relevant to medication history of patients (medication history data), and others. The medication history data included in the individual and medication-history data includes medicine dispensing data composed of information relevant to medicines dispensed for users in the pharmacy or the like, information relevant to prescriptions of medicines, and others. Note that the health data managed in the pharmacy database 411 is not limited to the medication history data, but may be any data as far as relevant to the health of a patient. The medication history data recorded in the pharmacy database 411 is transmitted to and recorded in the data center 100 as necessary, and is shared in a plurality of hospital systems 300 and pharmacy systems 400.

The input unit 412 is, for example, an input device composed of a keyboard, a mouse, a touch panel, and the like, and supplies information in response to input manipulation of a user, to the control unit 413. The control unit 413 controls the operation of the pharmacy rezept computer 410 in response to the information supplied from the input unit 412.

The pharmacy device 420 is composed of, for example, a desktop computer, a notebook computer, or the like. The pharmacy device 420 executes various process in response to the individual identification ID supplied from the reader-writer 430, and the input manipulation of a pharmacist, a staff member, and others. As shown in FIG. 4, the pharmacy device 420 includes an acquisition unit 421, a control unit 422, a communication unit 423, and a display unit 424.

The acquisition unit 421 acquires the individual identification ID acquired by the reader-writer 430 by contactless proximity communication with the IC card 20. The control unit 422 executes controls for exchanging various data with the pharmacy rezept computer 410 via a local area network, and for causing the display unit 424 to display various data.

The communication unit 423 transmits information to and receives information from other devices via a local area network and the network 10. The display unit 424 displays various data (text information, image information, and the like).

The reader-writer 430 is connected to the pharmacy device 420 by a USB (Universal Serial Bus) and other interfaces, and performs contactless proximity communication by a predetermined frequency (for example, 13.56 MHz) with the IC card 20. By performing the contactless proximity communication with the IC card 20, the reader-writer 430 provides the individual identification ID acquired from the IC card 20, to the pharmacy device 420.

In the above, the exemplary configuration of the pharmacy system 400 is described using FIG. 4. Note that the pharmacy rezept computer 410, the pharmacy device 420, and the reader-writer 430 illustrated in FIG. 4 may be configured by one device. Next, description will be made of a specific example of the individual and medication-history information recorded in the pharmacy database 410 of the pharmacy system 400.

### Specific Example of Pharmacy Database

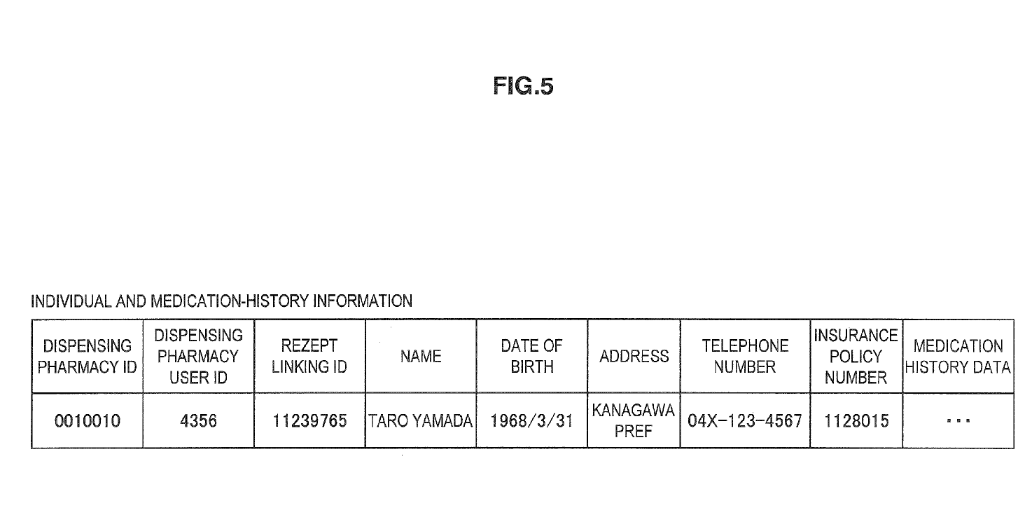

FIG. 5 is an explanatory diagram illustrating an example of the individual and medication-history information recorded in the pharmacy database 410 of the pharmacy system 400. In the example illustrated in FIG. 5, the individual and medication-history information includes “dispensing pharmacy ID”, “dispensing pharmacy user ID”, “rezept linking ID”, “name”, “date of birth”, “address”, “telephone number”, “insurance policy number”, and “medication history data”.

The “dispensing pharmacy ID” is information for singling out the pharmacy system 400, i.e. the pharmacy, identifiable in each device composing the information processing system 1 illustrated in FIG. 1. For example, an insurance medical institution code or the like used when each institution such as a pharmacy claims payment from an insurer is the dispensing pharmacy ID.

The “dispensing pharmacy user ID” is information for identifying a user, which is used only in the pharmacy system 400, i.e., the local system composed of the pharmacy rezept computer 410, the pharmacy device 420, and the reader-writer 430. For example, the user number or the like registered in the pharmacy rezept computer 410 composing the pharmacy system 400 is the dispensing pharmacy user ID.

Accordingly, only each device such as the pharmacy device 420 composing the pharmacy system 400 can single out the patient indicated by the dispensing pharmacy user ID on the basis of the dispensing pharmacy user ID. The dispensing pharmacy user ID like this is the information not singling out the patient directly, even if obtained by somebody.

The “rezept linking ID” is the information to link the individual identification ID identifying an individual patient, and the data retained in the health insurance association system 200.

Also, the “name”, the “date of birth”, the “address”, the “telephone number”, and the “insurance policy number” included in the individual and medication-history information is the name, the date of birth, the address, the telephone number, and the insurance policy number of the user singled out by the “dispensing pharmacy user ID”. These “name” to “insurance policy number” are what is referred to as individual information of a patient, which enables somebody to single out the user directly.

The “medication history data” included in the individual and medication-history information is the medication history data of the user singled out by the “dispensing pharmacy user ID”. This medication history data includes the medicine dispensing data and others input in the pharmacy system 400. In other words, the medication history data recorded in the pharmacy database 411 of each pharmacy (pharmacy system 400) includes only information input in the pharmacy, but does not include information relevant to medication history input in other pharmacies and hospitals (other medical institution and the like).

More specifically, the medication history data includes, for example, a dispensing medicine ID singling out the dispensed medicine, a type of the dispensed medicine such as oral administration, a dispensing date and time, a prescribed number of days of the medicine, a use frequency of the medicine, an administration quantity of the medicine for one dose, information relevant to side effects, and the others, as the medicine dispensing data.

In this way, the individual and medication-history information includes the dispensing pharmacy ID singling out pharmacy, the dispensing pharmacy user ID identifying the user in the pharmacy, the individual information of the user such as a name, and the medication history data input in the pharmacy.

In the hospital system 300 and the pharmacy system 400 composing the information processing system 1 of FIG. 1, the individual and physical-examination information and the individual and medication-history information including the medication history data input in those respective systems are managed in the hospital database 311 and the pharmacy database 411 for each patient.

Note that the medication history data included in the individual and physical-examination information managed in the hospital database 311 includes information relevant to prescriptions issued to patients in the hospital (physical examination data). Specifically, the medication history data includes, for example, an issue date and time of a prescription, possibility or impossibility of change to generic drugs, a prescribed medicine ID singling out the prescribed medicine, a type of the prescribed medicine such as the oral administration, a prescribed number of days of the medicine, a use frequency of the medicine, an administration quantity of the medicine for one dose, information relevant to side effects, and others.

Also, the individual and physical-examination information managed in the hospital database 311 includes a “hospital ID” and a “hospital user ID” in place of the “dispensing pharmacy ID” and the “dispensing pharmacy user ID” of FIG. 5. The “hospital ID” is the information corresponding to the “dispensing pharmacy ID”, and is the information singling out the hospital system 300 in the information processing system. The “hospital user ID” is the information corresponding to the “dispensing pharmacy user ID”, and is the patient identification information used only in the hospital system 300.

In the above, the specific example of the individual and medication-history information recorded in the pharmacy database 410 of the pharmacy system 400 is described. Next, description will be made of a specific example of the user medication history information recorded in the server database 111 of the data server 110.

### Specific Example of Server Database

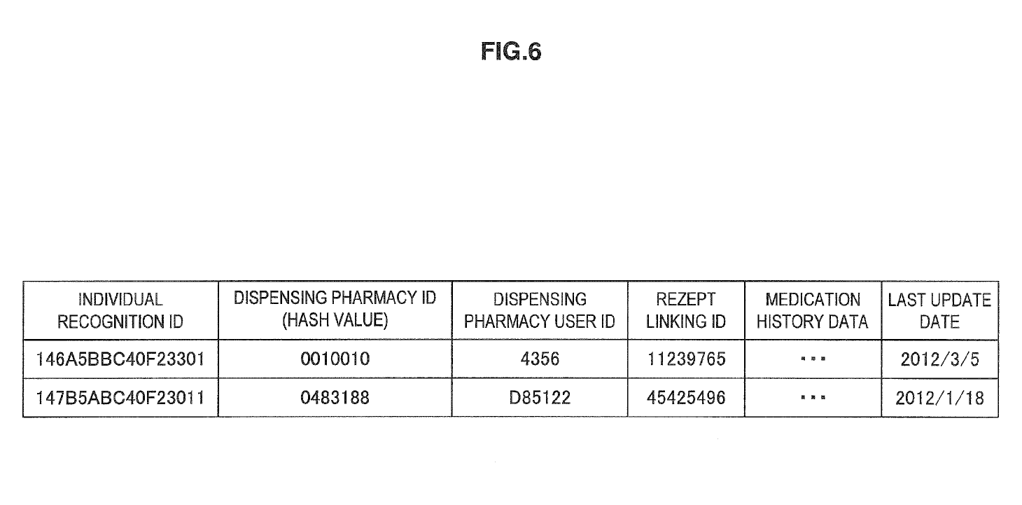

FIG. 6 is an explanatory diagram illustrating a specific example of the user medication history information recorded in the server database 111 of the data server 110. In an example illustrated in FIG. 6, each user medication history information includes the “individual identification ID”, the “dispensing pharmacy ID”, the “dispensing pharmacy user ID”, the “rezept linking ID”, the “medication history data”, and the “last update date”.

The “individual identification ID” included in the user medication history information is the individual identification ID recorded in the IC card 20 illustrated in FIG. 1 and others. This individual identification ID is used as the information singling out the patient who owns the IC card 20 as described above. Also, the “dispensing pharmacy ID” is the dispensing pharmacy ID singling out the pharmacy system 400. More specifically, the “dispensing pharmacy ID” included in the user medication history information is converted to a hash value obtained by hashing the dispensing pharmacy ID.

The “dispensing pharmacy user ID” is the dispensing pharmacy user ID identifying a patient in the pharmacy system 400. The “rezept linking ID” is the information linking the individual identification ID identifying the individual patient and the data retained in the health insurance association system 200. The “medication history data” is the medication history data input in the pharmacy system 400 singled out by the dispensing pharmacy ID. The “last update date” is the date when the data of each individual identification ID in the server database 111 is updated last time.

Note that, more specifically, in the user medication history information including the medication history data relevant to the hospital system 300, the “hospital ID” and the “hospital user ID” are used in place of the “dispensing pharmacy ID” and the “dispensing pharmacy user ID”.

In the above, the specific example of the user medication history information recorded in the server database 111 of the data server 110 is described. Next, description will be made of the exemplary registration process of the user medication history information.

### Exemplary Registration Process of User Medication History Information

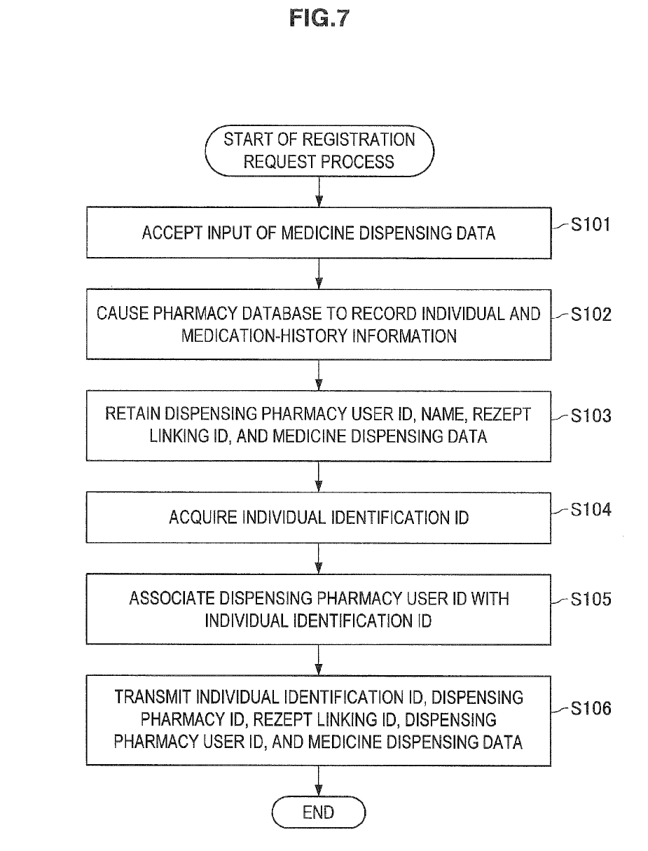

FIG. 7 is a flow diagram illustrating an exemplary registration process of the user medication history information by the pharmacy system 400. In the following, description will be made of the exemplary registration process of the user medication history information by the pharmacy system 400, using FIG. 7.

When a new user visits the pharmacy provided with the pharmacy system 400 and submits the prescription, a pharmacist and others in the pharmacy manipulate the input unit 412 of the pharmacy rezept computer 410, and start inputting the medicine dispensing data of the user, on the basis of the submitted prescription. Then, the control unit 413 accepts the input of the medicine dispensing data, and acquires information in response to manipulation of the input unit 412 by the pharmacist and others as the medicine dispensing data (step S101).

Also, when a user first visits the pharmacy provided with the pharmacy system 400, since the information relevant to the user, such as the individual information, is not registered (recorded) in the database 411 in medicine, the pharmacist and others manipulate the input unit 412 to input the individual information such as a name and a date of birth of the user. Also, the pharmacist and others manipulate the input unit 412 to input a rezept linking ID, or a passcode which will be the basis of the rezept linking ID, for making a connection between the individual identification ID described later and the insurance policy number of the user.

For example, when the individual and medication-history information illustrated in FIG. 5 is recorded in the pharmacy database 411, the pharmacist and others input the name, the date of birth, the address, the telephone number, and the insurance policy number of the user, and allocate the dispensing pharmacy user ID of the user as necessary. When these information is input, the control unit 413 generates the medication history data from the medicine dispensing data acquired from the input unit 412, and generates the individual and medication-history information from the information such as the input name of the user, the generated medication history data, and the dispensing pharmacy user ID allocated to the user.

Note that, if the user arrived at the pharmacy previously and the individual and medication-history information of the user is already recorded in the pharmacy database 411, the generation of the individual and medication-history information is not conducted.

Subsequently, the control unit 413 supplies the generated individual and medication-history information to the pharmacy database 411 and causes the pharmacy database 411 to record the generated individual and medication-history information, and supplies the dispensing pharmacy user ID, the name of the user, and the medicine dispensing data (medication history data) acquired in the process of step S101 to the pharmacy device 420 via the local area network (step S102).

Subsequently, the control unit 422 of the pharmacy device 420 temporarily retains the dispensing pharmacy user ID supplied from the control unit 413, the rezept linking ID (or the passcode), the name of the user, and the medicine dispensing data (step S103).

When finishing the input of the medicine dispensing data, the individual information, etc of the user, the pharmacist and others dispense the prescribed medicine as necessary and administer the medicine to the user. Further, when the user visits the pharmacy for the first time, the pharmacist and others ask the user if he or she desires a new registration of the electronic medicine notebook. In other words, the pharmacist and others ask about the desire for the user register to the data center 100.

When the user desires the new registration of the electronic medicine notebook, the pharmacist and others manipulate the pharmacy device 420 to conduct the process for the new registration. The control unit 422 of the pharmacy device 420 supplies the dispensing pharmacy user ID, the name of the user, and the medicine dispensing data, which are retained temporarily, to the display unit 424 in response to manipulation by the pharmacist and others, and causes the display unit 424 to display the dispensing pharmacy user ID, the name of the user, and the medicine dispensing data.

The pharmacist, others and the user confirm the information such as the name displayed on the display unit 424, and thereafter the user puts the IC card 20, which the user carries, over the reader-writer 430. Then, the reader-writer 430 performs contactless proximity communication with the IC card 20, and receives the individual identification ID from the IC card 20. The acquisition unit 421 acquires the individual identification ID of the user from the reader-writer 430, and supplies the individual identification ID of the user to the control unit 422 (step S104).

Subsequently, the control unit 422 associates the dispensing pharmacy user ID of the user, which the control unit 422 retains temporarily, with the individual identification ID supplied from the acquisition unit 421 (step S105). Then, the control unit 422 acquires the dispensing pharmacy ID of the pharmacy system 400 from the pharmacy rezept computer 410 as necessary, and conducts hashing of the dispensing pharmacy ID. Then, the control unit 422 supplies the hash value (dispensing pharmacy ID) obtained by computation of the hashing, the individual identification ID, the dispensing pharmacy user ID, the rezept linking ID, and the medicine dispensing data, to the communication unit 433.

The communication unit 423 transmits the dispensing pharmacy ID (hash value), the individual identification ID, the dispensing pharmacy user ID, the rezept linking ID, and the medicine dispensing data, which are supplied from the control unit 422, via the network 10 to the data server 110 (step S106), and ends the registration request process. In other words, the communication unit 423 transmits a request for a new registration of the user, which includes the dispensing pharmacy ID, the individual identification ID, the dispensing pharmacy user ID, the rezept linking ID, and the medicine dispensing data.

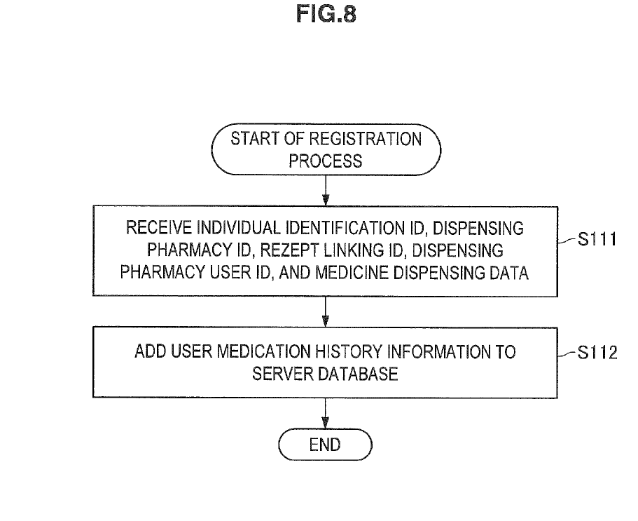

When the request of a new registration is transmitted from the pharmacy system 400 in this way, the data server 110 conducts registration process in response to the request. FIG. 8 is a flow diagram illustrating the registration process of the individual and medication-history information by the data server 110. In the following, description will be made of the registration process of the individual and medication-history information by the data server 110, using FIG. 8.

The communication unit 112 receives, and supplies to the update unit 113, the dispensing pharmacy ID (hash value), the individual identification ID, the dispensing pharmacy user ID, the rezept linking ID, and the medicine dispensing data, which are transmitted from the pharmacy system 400 (step S111). The update unit 113 generates the user medication history information including the dispensing pharmacy ID (hash value), the individual identification ID, the dispensing pharmacy user ID, the rezept linking ID, the medicine dispensing data, and the last update date, which are supplied from the communication unit 112, and adds the generated user medication history information to the server database 111 (step S112). In other words, the newly generated user medication history information is recorded in the server database 111. Thereby, the user medication history information illustrated in FIG. 6 for example is newly recorded. Note that, at the time of the generation of the user medication history information, the update unit 113 sets the medicine dispensing data of the user as it is, as the medication history data.

When the newly generated user medication history information is recorded in the server database 111, the new registration of the user is completed, and the registration process ends.

As above, the pharmacy system 400 transmits the dispensing pharmacy ID singling out the pharmacy, the individual identification ID singling out the user, and the dispensing pharmacy user ID, as well as the medicine dispensing data of the user, to the data server 111, and requests the registration of the user. Also, the data server 110 receives these information transmitted from the pharmacy system 400, and generates and registers the user medication history information.

At the time of registration, the individual identification ID, the rezept linking ID, and the dispensing pharmacy user ID are exchanged as the information for singling out the user between the pharmacy system 400 and the data server 110 via the network 20. However, since it is generally almost impossible to single out the individual user even if somebody takes a look at these information, the individual information is prevented from leaking, and thereby the security of the system is improved.

Also, while the dispensing pharmacy ID for singling out the pharmacy is exchanged between the pharmacy system 400 the data server 110 at the time of registration, this dispensing pharmacy ID is hashed, i.e., a hash value. Accordingly, since it is difficult for somebody to single out the pharmacy from the hash value, the security is improved.

In this way, the electronized medicine dispensing data is built in the data server 110, without singling out the individual. However, like the conventional medicine notebook made of paper, if the patient forgets to bring the IC card to the pharmacy, the medicine dispensing data built in the data server 110 becomes incomplete as well. Also, there is a case where the individual information includes a typographical error, a case where a part of the information is not classified correctly, or a case where classification itself does not exist. Further, even if the electronic medicine notebook become widespread, it takes long time to accumulate the data.

On the other hand, since the data built in the health insurance association system 200 is checked by the examination and payment institution and the health insurance association during the processing and, if defective, is sent back to the hospital and the pharmacy, the data is highly accurate covering all medication history of the individual. However, because of the time taken to check and send back, the generation of the medicine dispensing data in the health insurance association system 200 is delayed about two month from the prescription of the medicine.

Therefore, in the present embodiment, the data built in the data server 110 and the data built in the health insurance association system 200 are linked using the rezept linking ID. Thereby, the highly accurate medicine dispensing data is built in the data server 110, without retaining the individual information itself in the data server 110.

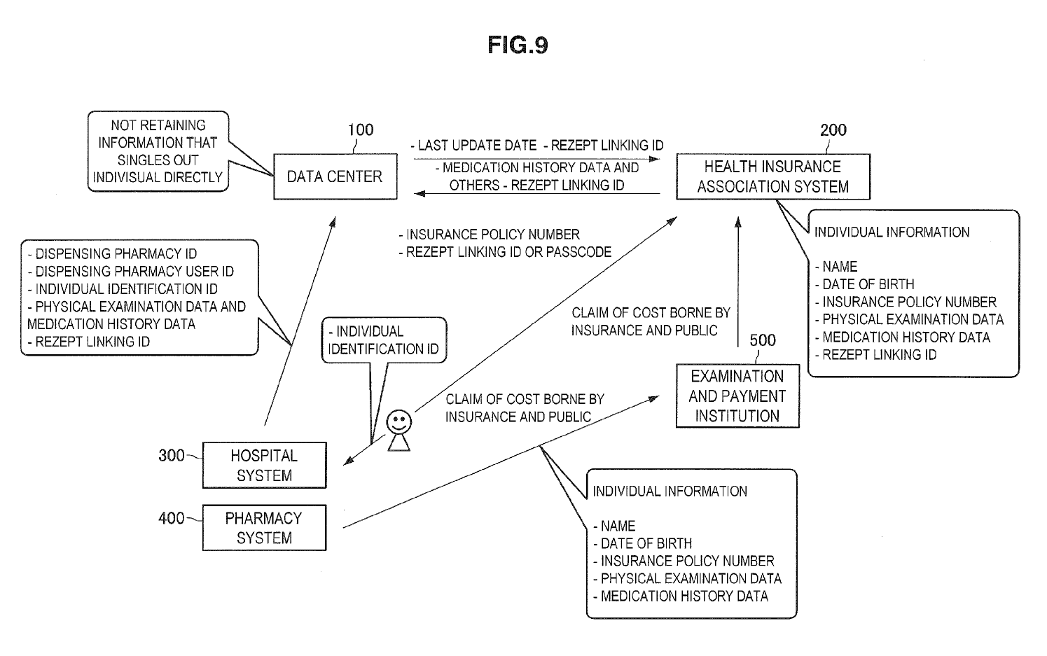

FIG. 9 is an explanatory diagram illustrating an overview of the operation of the information processing system 1 according to the present embodiment. When the user presents the IC card 20 to the hospital system 300 and the pharmacy system 400, the individual identification ID registered in the IC card 20 is provided to the hospital system 300 and the pharmacy system 400. The hospital system 300 and the pharmacy system 400 transmits the dispensing pharmacy ID, the dispensing pharmacy user ID, the individual identification ID, the physical examination data, the medication history data, and the rezept linking ID, to the data center 100. The data center 100 builds the user medication history information from the transmitted data. The data center 100 does not retain the information singling out the individual directly, such as a name, a date of birth, and an address.

The user, as well as the hospital system 300 and the pharmacy system 400, creates the rezept linking ID for linking with the electronic rezept of the health insurance association 200, or the original data for generating the rezept linking ID (the passcode or the like which is the seed of the encryption), and registers the rezept linking ID or the original data in the health insurance association 200 in advance. If the original data for generating the rezept linking ID is registered, the health insurance association system 200 generates the rezept linking ID from the original data. For example, the health insurance association system 200 generates as the rezept linking ID, and retains in the inside, the one-way hash of the character string composed of the insurance policy number of the user, the date of birth of the user, and the passcode, using the hash function such as SHA-256.

Also, the hospital system 300 and the pharmacy system 400 executes the claim process of the cost borne by insurance and public to the examination and payment institution 500. During this, the name, the date of birth, the insurance policy number, the physical examination data and the medical treatment data are transmitted from the hospital system 300 and the pharmacy system 400 to the examination and payment institution 500. The examination and payment institution 500 checks the data, and sends the data back to the hospital and the pharmacy if the data is deficient. If the data is fixed, the examination and payment institution 500 executes the claim process of the cost borne by insurance and public to the health insurance association system 200.

Then, the inquiry of the medication history data is transmitted from the data center 100 to the health insurance association system 200 at a predetermined timing, using the last update date and the rezept linking ID. In response to the inquiry, the health insurance association system 200 returns the rezept linking ID and the medication history data to the data center 100. The data center 100 updates the medication history data transmitted from the health insurance association system 200, using the rezept linking ID as a key.

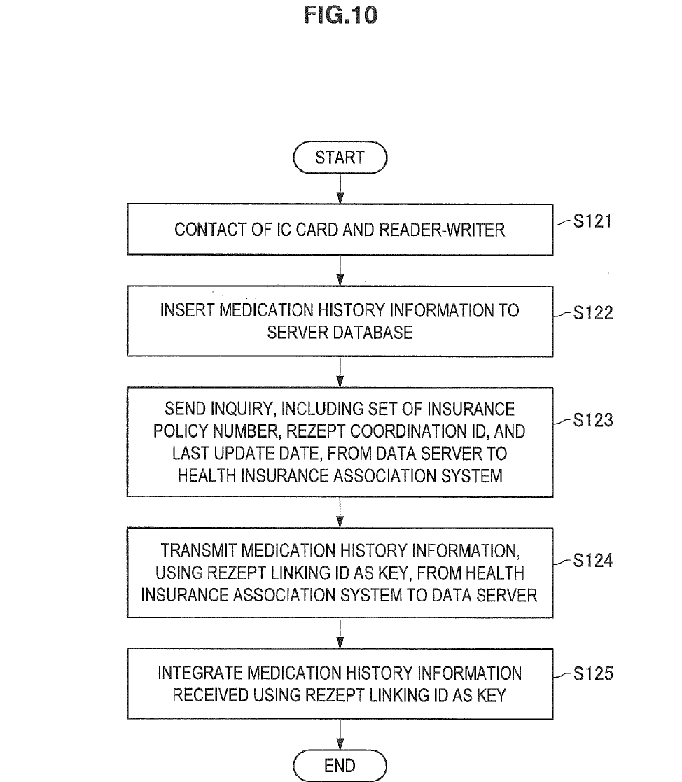

FIG. 10 is a flow diagram illustrating one example of the processing operation of the information processing system 1 according to one embodiment of the present disclosure. A flow diagram illustrated in FIG. 10 illustrates an operation when the medication history data is registered from the pharmacy system 400 into the data center 100.

When the user brings the IC card 20 to the pharmacy and makes the IC card 20 in touch with the reader-writer 430 (step S121), the processes illustrated in FIG. 7 and FIG. 8 are executed in the pharmacy system 400 and the data server 110, and the individual and medication-history information is inserted into the server database 111 of the data server 110 (step S122).

When the individual and medication-history information is inserted into the server database 111 of the data server 110, the data server 110 makes a set of the insurance policy number, the rezept linking ID, and the last update date, and sends an inquiry for the medication history information of the user who has the rezept linking ID to the health insurance association system 200 (step S123). The health insurance association system 200 acquires the medication history information from the database or the like retained internally using the rezept linking ID as a key, and transmits the acquired medication history information to the data server 110 of the inquiry source (step S124).

The data server 110 integrates the received medication history information into the server database 111 using the rezept linking ID as a key (step S125).

By a series of processes illustrated in FIG. 10, the information processing system 1 according to one embodiment of the present disclosure enables linking with the medication history information retained in the health insurance association system 200, without retaining information, such as a name and an address, for directly singling out an individual patient in the data center 100.

While what is illustrated in FIG. 9 and FIG. 10 is the most basic case, the health insurance association side may know the passcode in advance for example, or an inquiry for the medication history information may be sent from the user, the hospital, or the pharmacy to the health insurance association directly, not through the data server 110.

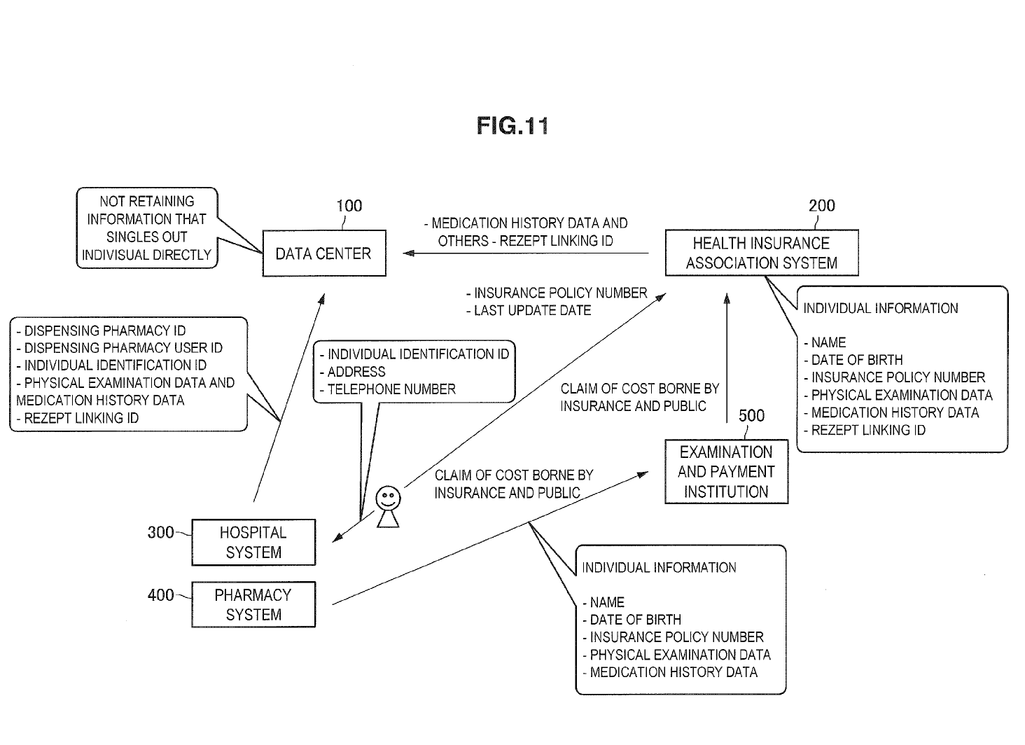

FIG. 11 is an explanatory diagram illustrating an overview of the operation of the information processing system 1 according to the present embodiment. The overview of the operation illustrated in FIG. 11 is different from what is illustrated in FIG. 9, and illustrates a case where an inquiry for the medication history information is sent from the user, the hospital, and the pharmacy to the health insurance association directly, not through the data server 110. FIG. 11 illustrates an example where the user, the hospital system 300, and the pharmacy system 400 send an inquiry for the medication history information directly to the health insurance association system 200, and the health insurance association system 200 transmits the result for the inquiry to the data server 110.

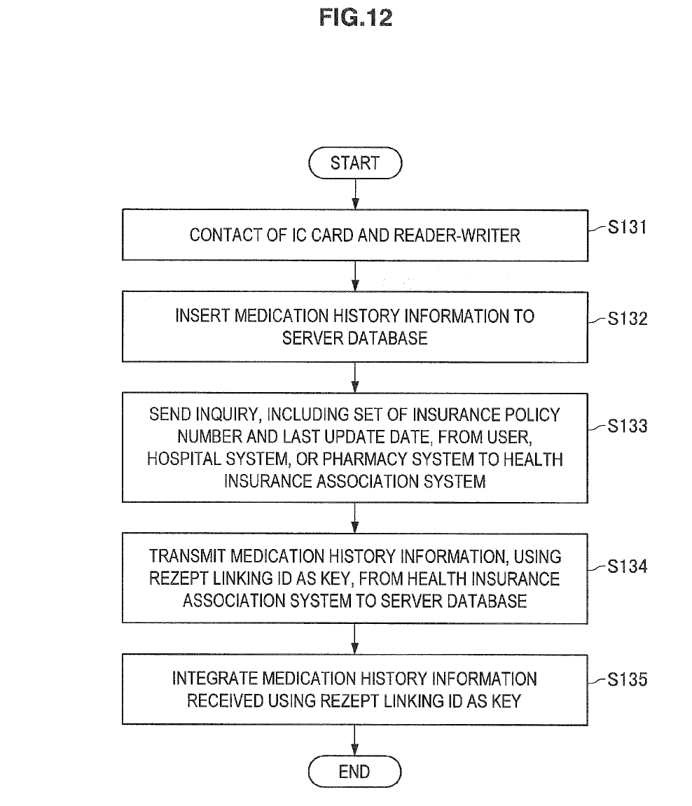

FIG. 12 is a flow diagram illustrating one example of the processing operation of the information processing system 1 according to one embodiment of the present disclosure. A flow diagram illustrated in FIG. 12 illustrates an operation when the medication history data is registered from the pharmacy system 400 into the data center 100.

When the user brings the IC card 20 to the pharmacy and makes the IC card 20 in touch with the reader-writer 430 (step S131), the processes illustrated in FIG. 7 and FIG. 8 are executed in the pharmacy system 400 and the data server 110, and the individual and medication-history information is inserted into the server database 111 of the data server 110 (step S132).

When the individual and medication-history information is inserted into the server database 111 of the data server 110, the user, the hospital system 300, and the pharmacy system 400 make a set of the insurance policy number and the last update date, calculate the rezept linking ID from the insurance policy number, and send an inquiry for the medication history information of the user who has the rezept linking ID to the health insurance association system 200 (step S133). The health insurance association system 200 acquires the medication history information from the database or the like retained internally using the rezept linking ID as a key, and transmits the acquired medication history information to the data server 110 of the inquiry source (step S134).

The data server 110 integrates the received medication history information into the server database 111 using the rezept linking ID as a key (step S135).

By a series of processes illustrated in FIG. 12, the information processing system 1 according to one embodiment of the present disclosure enables linking with the medication history information retained in the health insurance association system 200, without retaining information, such as a name and an address, for directly singling out an individual patient in the data center 100. Also, since the rezept linking ID is not used when an inquiry is sent from the user, the hospital system 300, and the pharmacy system 400, even if all communication from the user, the hospital system 300, and the pharmacy system 400 is wiretapped, a connection cannot be made to the rezept linking ID, and therefore it is impossible to acquire the medication history information from the data server 110, which improves the security.

In the example described up to here, the trigger of transmission start of the medication history information from the health insurance association system 200 to the data server 110 is the inquiry from the data server 110, the user, the hospital system 300, and the pharmacy system 400, but the present disclosure is not limited to such an example. For example, the medication history information may be transmitted automatically from the health insurance association system 200 to the data server 110 at the timing the data is updated from the examination and payment institution 500 to the health insurance association system 200.

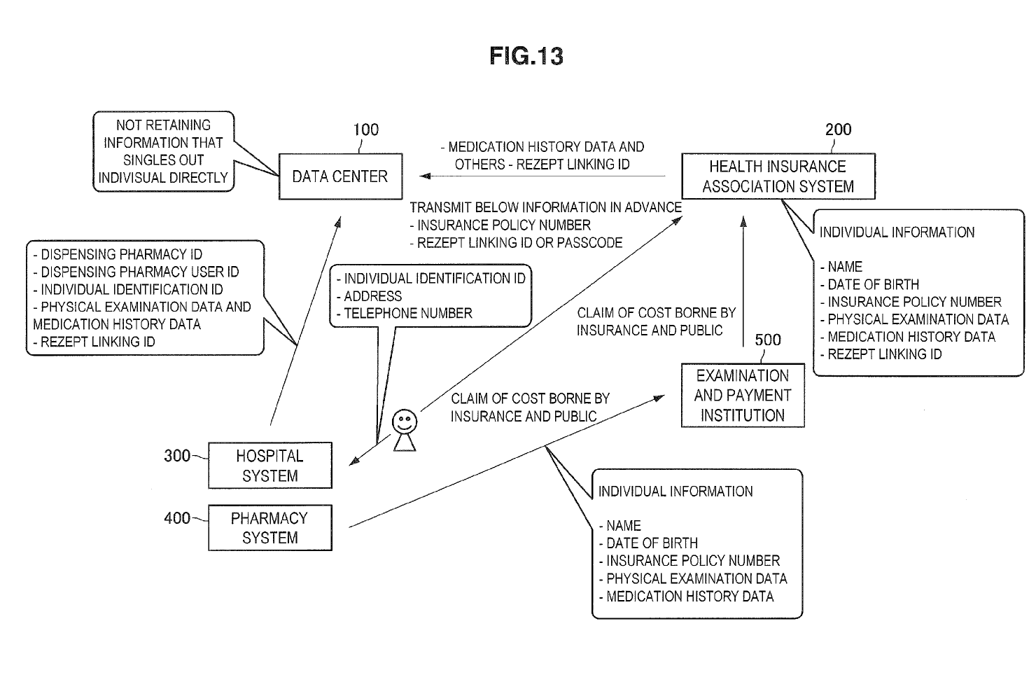

FIG. 13 is an explanatory diagram illustrating an overview of the operation of the information processing system 1 according to the present embodiment. The overview of the operation illustrated in FIG. 13 is different from what is illustrated in FIG. 9 and FIG. 11, and illustrates a case where the medication history information is transmitted automatically from the health insurance association system 200 to the data server 110 at the timing the data is updated from the examination and payment institution 500 to the health insurance association system 200. Like this, in order to configure such that the medication history information is transmitted automatically from the health insurance association system 200 to the data server 110, the rezept linking ID or the data that is the basis of the rezept linking ID is registered in advance into the health insurance association system 200 from the user, the hospital system 300, and the pharmacy system 400.

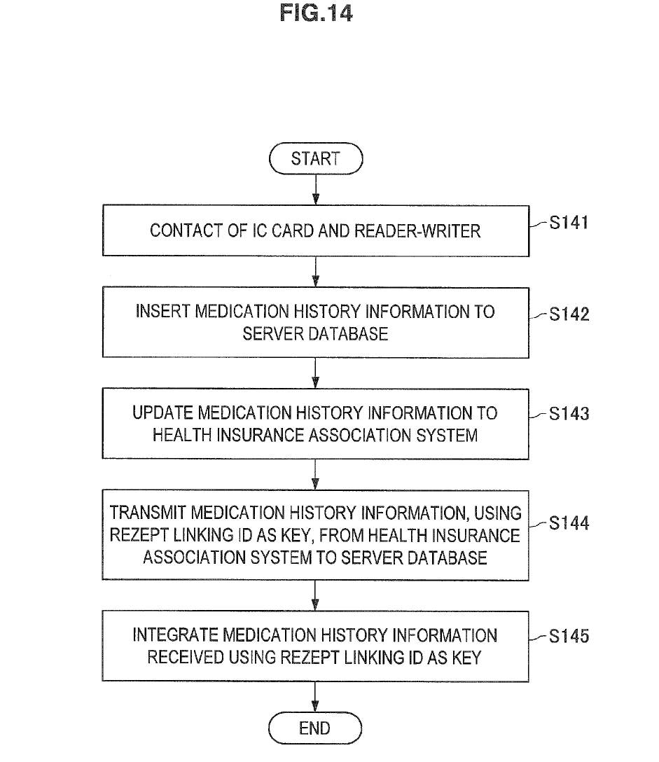

FIG. 14 is a flow diagram illustrating one example of the processing operation of the information processing system 1 according to one embodiment of the present disclosure. A flow diagram illustrated in FIG. 14 illustrates an operation when the medication history data is registered from the pharmacy system 400 into the data center 100.

When the user brings the IC card 20 to the pharmacy and makes the IC card 20 in touch with the reader-writer 430 (step S141), the processes illustrated in FIG. 7 and FIG. 8 are executed in the pharmacy system 400 and the data server 110, and the individual and medication-history information is inserted into the server database 111 of the data server 110 (step S142).

When the individual and medication-history information is inserted into the server database 111 of the data server 110, and thereafter the medication history information is updated to the health insurance association system 200 (step S143), the health insurance association system 200 is triggered by the update to acquire the medication history information from the database or the like retained internally using the rezept linking ID as a key, and to transmit the acquired medication history information to the data server 110 of the inquiry source (step S144).

The data server 110 integrates the received medication history information into the server database 111 using the rezept linking ID as a key (step S145).

By a series of processes illustrated in FIG. 12, the information processing system 1 according to one embodiment of the present disclosure enables linking with the medication history information retained in the health insurance association system 200, without retaining information, such as a name and an address, for directly singling out an individual patient in the data center 100. Also, at the timing when the data is updated from the examination and payment institution 500 to the health insurance association system 200, the medication history information is transmitted automatically from the health insurance association system 200 to the data server 110, and thereby the concern of the wiretapping of the data is removed, which improves the security of the system.

### 2. Conclusion

As described above, according to the present embodiment, the data of the electronic medicine notebook, which is advantageously real-time but may be missing, and the data of the electronic rezept, which has a time lag but is more complete and highly accurate, are linked without performing communication including both of the medication history and the information singling out the individual. Thereby, the information processing system 1 according to the present embodiment can generate the medication history data that compensates for the property of being real-time and the property of being complete, one with the other.

Specifically, the linking can be made, from the date on which the electronic medicine notebook is made, with the data that is built in the health insurance association system 200 a predetermined period or more before (for example, two month or more before). Thereby, there are much information, and all data, since the rezept is electronized, is stocked in the data server 110, if the user uses the electronic medicine notebook for a predetermined period. Of course, even if the electronic medicine notebook is not used, when a predetermined period of time lapses, the data of the data server 110 is compensated for from the electronic rezept.

The timing of the data linking between the data server 110 and the health insurance association system 200 may be the timing when the user makes the IC card 20 in touch with the reader-writer and new medication history information is registered in the data server 110, and may be the timing when an inquiry is sent from the user, the hospital system 300, and the pharmacy system 400, and may be the timing when the data is updated from the examination and payment institution 500 to the health insurance association system 200. In any case, the data linking between the data server 110 and the health insurance association system 200 is conducted securely and at a proper timing.

The preferred embodiments of the present invention have been described above with reference to the accompanying drawings, whilst the present invention is not limited to the above examples, of course. A person skilled in the art may find various alterations and modifications within the scope of the appended claims, and it should be understood that they will naturally come under the technical scope of the present invention.

For example, each step in the process that each device of the present specification executes is not necessarily required to be processed sequentially in the order described as the sequence diagram or the flowchart. For example, each step in the process that each device executes may be processed in the order different from the order described as a flowchart, or may be processed parallelly.

Also, a computer program that causes a hardware such as a CPU, a ROM and a RAM built in each device to serve a function equivalent to the configuration of each device described above can be created. Also, the storage medium storing the computer program is provided. Also, the series of the process can be achieved with a hardware, by configuring the respective functional blocks illustrated in the functional block diagram with a hardware.

Additionally, the present technology may also be configured as below.

(1)

A server device including:

a data retaining unit configured to retain at least data of each individual, without retaining information that identifies a specific individual; and

a data registration unit configured to acquire at least data of each individual from another system retaining at least information that identifies a specific individual and the data of each individual, and register the data of each individual in the data retaining unit,

wherein the data registration unit acquires data from the another system using a linking ID for making a linkage with the another system, and registers the data in the data retaining unit.

(2)

The server device according to (1), wherein the data of each individual is data relevant to health.

(3)

The server device according to (2), wherein the data registration unit acquires data relevant to health from the another system using the linking ID and registers the data in the data retaining unit, at a timing when the data relevant to health of each individual is transmitted.

(4)

The server device according to (2) or (3), wherein the data registration unit acquires the data relevant to health of each individual transmitted at a predetermined timing from the another system, and registers the data in the data retaining unit using the linking ID.

(5)

The server device according to any one of (2) to (4), wherein

the data retaining unit has information of a last update date, and

the data registration unit acquires the data relevant to health of each individual on or after the last update date from the another system and registers the data in the data retaining unit.

(6)

The server device according to any one of (2) to (5), wherein the linking ID is generated by one-way hashing.

(7)

The server device according to any one of (2) to (6), wherein the another system is a system that uses an electronic rezept.

(8)

A data linking method including:

a step of acquiring at least data of each individual from another system retaining at least information that identifies a specific individual and the data of each individual, and registering the data in a data retaining unit retaining at least data of each individual without retaining information that identifies a specific individual,

wherein, in the step of registering in the data retaining unit, data is acquired from the another system using a linking ID for making a linkage with the another system, and is registered in the data retaining unit.

(9)

A computer program causing a computer to execute:

a step of acquiring at least data of each individual from another system retaining at least information that identifies a specific individual and the data of each individual, and registering the data in a data retaining unit retaining at least data of each individual without retaining information that identifies a specific individual,

wherein, in the step of registering in the data retaining unit, data is acquired from the another system using a linking ID for making a linkage with the another system, and is registered in the data retaining unit.

### REFERENCE SIGNS LIST

1 information processing system
100 data center
110 data server
111 server database
112 communication unit
113 update unit
114 user search unit
115 medication history search unit
120 information processing server
200 health insurance association system
300 hospital system
400 pharmacy system

1. A server device comprising:
a data retaining unit configured to retain at least data of each individual, without retaining information that identifies a specific individual; and
a data registration unit configured to acquire at least data of each individual from another system retaining at least information that identifies a specific individual and the data of each individual, and register the data of each individual in the data retaining unit,
wherein the data registration unit acquires data from the another system using a linking ID for making a linkage with the another system, and registers the data in the data retaining unit.

2. The server device according to claim 1, wherein the data of each individual is data relevant to health.

3. The server device according to claim 2, wherein the data registration unit acquires data relevant to health from the another system using the linking ID and registers the data in the data retaining unit, at a timing when the data relevant to health of each individual is transmitted.

4. The server device according to claim 2, wherein the data registration unit acquires the data relevant to health of each individual transmitted at a predetermined timing from the another system, and registers the data in the data retaining unit using the linking ID.

5. The server device according to claim 2, wherein
the data retaining unit has information of a last update date, and
the data registration unit acquires the data relevant to health of each individual on or after the last update date from the another system and registers the data in the data retaining unit.

6. The server device according to claim 2, wherein the linking ID is generated by one-way hashing.

7. The server device according to claim 2, wherein the another system is a system that uses an electronic rezept.

8. A data linking method comprising:
a step of acquiring at least data of each individual from another system retaining at least information that identifies a specific individual and the data of each individual, and registering the data in a data retaining unit retaining at least data of each individual without retaining information that identifies a specific individual,
wherein, in the step of registering in the data retaining unit, data is acquired from the another system using a linking ID for making a linkage with the another system, and is registered in the data retaining unit.

9. A computer program causing a computer to execute:
a step of acquiring at least data of each individual from another system retaining at least information that identifies a specific individual and the data of each individual, and registering the data in a data retaining unit retaining at least data of each individual without retaining information that identifies a specific individual,
wherein, in the step of registering in the data retaining unit, data is acquired from the another system using a linking ID for making a linkage with the another system, and is registered in the data retaining unit.
